(19) United States
(12) Patent Application Publication
(10) Pub. No.: US 2005/0206099 A1
(43) Pub. Date: Sep. 22, 2005

(54) Frequency domain ride control for low bandwidth active suspension systems

(75) Inventor: Xubin Song, Canton, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/803,007

(22) Filed: Mar. 17, 2004

(51) Int. Cl. B60G 17/00

(52) U.S. Cl. 280/5.507

(57) ABSTRACT

The present invention provides a system and method for actively controlling the suspension of a vehicle. The system includes struts for providing an adjustable suspension to the vehicle, sensors to measure the strut relative displacement, and a controller configured to determine the frequency amplitude for the heave, pitch, or roll of the vehicle based on the strut relative displacement and manipulate the struts in response thereto.

### BACKGROUND

1. Field of the Invention

The present invention generally relates to a system and method for controlling a vehicle suspension.

2. Description of Related Art

Generally, people all over the world drive their automobiles to various destinations. In order for these people to enjoy the ride to their destinations the suspensions systems in the automobiles must be stable and as comfortable as possible. Different types of automobiles have various suspension systems, which control the ride and handling performance of the vehicle. For example, some vehicles may have a sport or stiff suspension system that limits movement of its vehicle chassis with respect to the road wheels, but provides less isolation from rough road surfaces. In contrast to the stiff suspension system, some vehicles may have a luxury or soft suspension system that provides a more comfortable ride by isolating the vehicle occupied from the rough road surface, but allowing increased vehicle chassis movement causing a decrease in the handling performance.

Recently, low-bandwidth active suspension control systems have been developed employing compressible fluid struts and digital displacement pump motors. One key enabling technology of these systems are efficient and effective control algorithms to fully utilize the actuation systems, while avoiding various difficulties of control algorithm implementation. One such difficulty includes developing frequency domain vibration control methods to achieve desired dynamic performance for a specific working frequency range. This frequency range, between zero and up to 30 Hz, provides two significant frequency modes, a body mode around 1 Hz and a wheel-hop mode around 11 Hz each requiring different suspension control strategies. To implement the control strategies, the control system utilizes the frequency amplitude of the vehicle heave, pitch, and roll to calculate the suspension system adjustment.

Generally, heave, pitch, and roll frequency information is determined using three body accelerometers. However, it would be advantageous to calculate heave, pitch, and roll frequency information using existing sensors thereby eliminating the need for the three body accelerometers. In view of the above, it is apparent there exists a need for an improved system and method for controlling a suspension system that does not require three body accelerometers.

### SUMMARY

In satisfying the above need, as well as overcoming the enumerated drawbacks and other limitations of the related art, an embodiment of the present invention provides a system for controlling the suspension of a vehicle. The system includes compressible fluid struts as components of vehicle suspension, sensors to measure a strut relative displacement, and a controller configured to determine the frequency amplitude for the heave, pitch, or roll of the vehicle based on the strut relative displacement.

In another aspect of the present invention, the controller includes a derivative filter to generate a strut relative velocity based on the strut relative displacement. Further, the strut relative velocity is used to calculate a body relative velocity. A first and second frequency amplitude are extracted from the body relative velocity to generate an effective frequency of the suspension. In addition, a desired strut pressure is calculated based on the effective frequency, the strut relative velocity, and the strut relative displacement. The struts are adjusted in accordance with the desired strut pressure to improve vehicle suspension performance.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a vehicle having a system for controlling a suspension system in accordance with the present invention;

FIG. 2 is a block diagram of an algorithm for controlling a suspension system in accordance with the present invention;

FIG. 3 is a block diagram of an algorithm for deriving three body relative velocities from four strut relative displacements in accordance with the present invention;

FIG. 4 is a block diagram of a frequency decoding algorithm in accordance with the present invention;

FIG. 5 is a block diagram of an algorithm for extracting frequency amplitude in a frequency decoding algorithm in accordance with the present invention;

FIG. 6 is a plot of a sample control strategy for heave stiffness control; and

FIG. 7 is a block diagram of an algorithm for determining desired strut pressure in accordance with the present invention.

### DETAILED DESCRIPTION

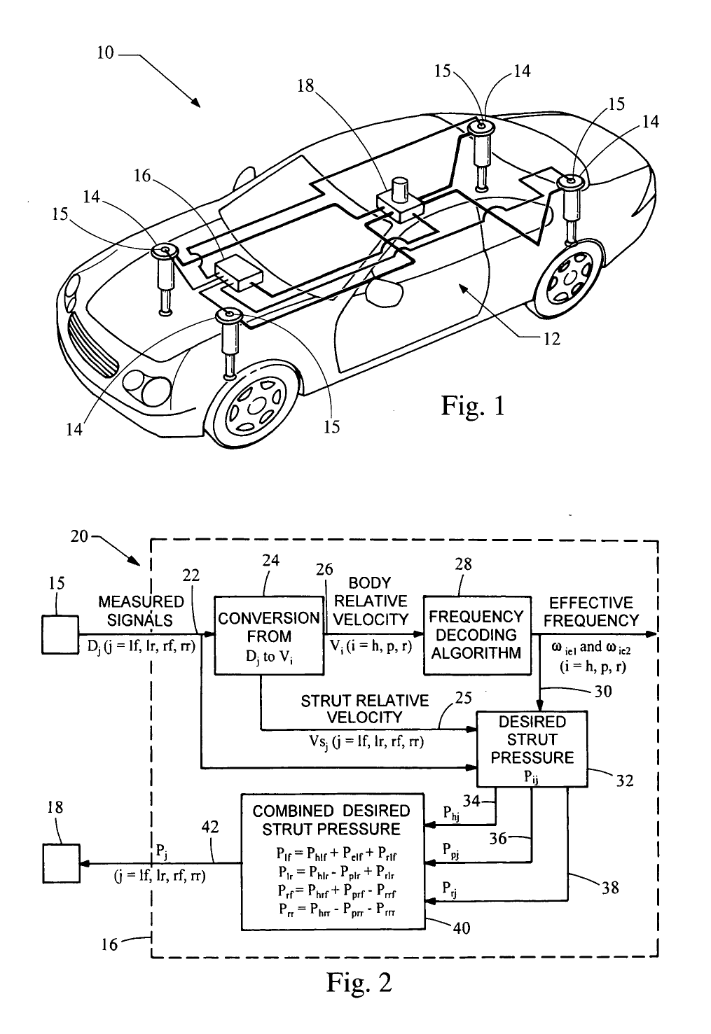

Referring now to FIG. 1, a system 12 for controlling the suspension of the vehicle 10 and embodying the principles of the present invention is provided. The system 12 includes an electronic control unit 16, a digital displacement pump motor (DDPM) 18, compressible fluid struts (CFS) 14, and displacement sensors 15. A suspension system of this general type is generally disclosed in U.S. patent application Ser. No. 10/688,095, filed on Oct. 17, 2003, which is hereby incorporated by reference.

Electronic control unit 16 interfaces with the displacement sensors 15 to collect strut relative displacement information. The strut displacement sensors are of the type well known in the industry and therefore need not be discussed in greater detail herein. Utilizing the strut relative displacement information, the electronic control unit 16 selects a control strategy to optimize the suspension performance and calculates the desired strut pressure information to implement the control strategy. The desired strut pressure is utilized to operate the DDPM 18 thereby tuning the stiffness and damping characteristics of each compressible fluid strut 14 in accordance with the control strategy.

Now referring to FIG. 2, the displacement sensors 15 provide the strut relative displacement 22 to a control algorithm 20 contained in the electronic control unit 16. Block 24 receives the strut relative displacement signals and converts the strut relative displacement signals to body relative velocities 26. In addition, block 24 also generates strut relative velocities 25 to be used in calculating the desired strut pressure 34, 36, 38. Block 28 receives the body relative velocities 26 and performs a frequency decoding algorithm to generate the effective frequencies 30. Block 32 then generates the desired strut pressure 34, 36, 38 based on the strut relative displacement 22, the strut relative velocity 25, and the effective frequencies 30. The desired strut pressure 34, 36, 38 is received by block 40 to calculate the combined desired strut pressure 42 for each strut 14. The combined desired strut pressure 42 is provided to the digital displacement pump motor 18 to effectuate a desired control strategy by adjusting the pressure in each strut 14. Various portions of the control algorithm 20 will be discussed in more detail below.

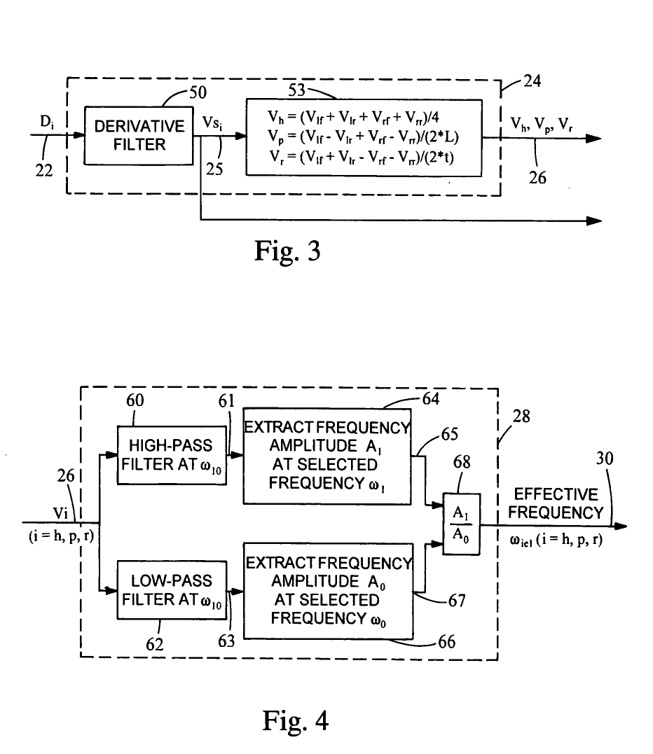

Now referring to FIG. 3, the details of block 24 are provided. The strut relative displacement signals 22 (D_{if}, Dᵢᵣ, D_{rf} and Dᵣᵣ) are received by the derivative filter 50, and the derivative filter 50 generates the strut relative velocities 25 (Vs_{if}, Vsᵢᵣ, Vs_{rf}, and Vsᵣᵣ). The strut relative velocities 25 are independently used to calculate the desired strut pressure as discussed later. Further, the strut relative velocities 25 are received by block 53 to generate the body relative velocities 26, or more specifically the body relative heave, pitch, and roll velocity (Vₕ, Vₚ and Vᵣ). For a specific vehicle, wheelbase (L) and tread (t) are known and used to calculate the body relative heave, pitch and roll velocities according to the relationship Vₕ=(V_{lf}+Vₗᵣ+V_{rf}+Vᵣᵣ)/4, Vₚ=(V_{lf}−Vₗᵣ+V_{rf}−Vᵣᵣ)/(2*L), and Vᵣ=(V_{lf}+Vₗᵣ−V_{rf}−Vᵣᵣ)/(2*t).

After the body relative velocity Vᵢ (i=h, p and r) is calculated, each signal can be used to extract the effective frequency ωᵢₑ₁ (i=h,p,r) for ride control. Now referring to FIG. 4, the frequency decoding algorithm 28 is applied at the vehicle body mode frequency range. Accordingly, the body relative velocity 26 is provided to a high-pass filter 60 and a low-pass filter 62. The vehicle body mode frequency is ω₁ (=2πf₁), therefore, a lower frequency ω₀ (about two or three times less than ω₁) can be selected, along with an intermediate frequency ω₀₁ between ω₀ and ω₁. These frequencies can be used as break frequencies for the high-pass filter 60 and the low-pass filter 62. The high-pass filtered body relative velocity 61 is used to extract a first frequency amplitude 65 (A₁) at the selected frequency ω₁, as denoted by block 64. Similarly, the low-pass filtered body relative velocity 63 is used to extract a second frequency amplitude 67 (A₀) at the selected frequency ω₀, as denoted by block 66. In block 68, the first frequency amplitude 65 in the second frequency amplitude 67 are combined according to the relationship A₁/A₀ to generate the effective frequency 30.

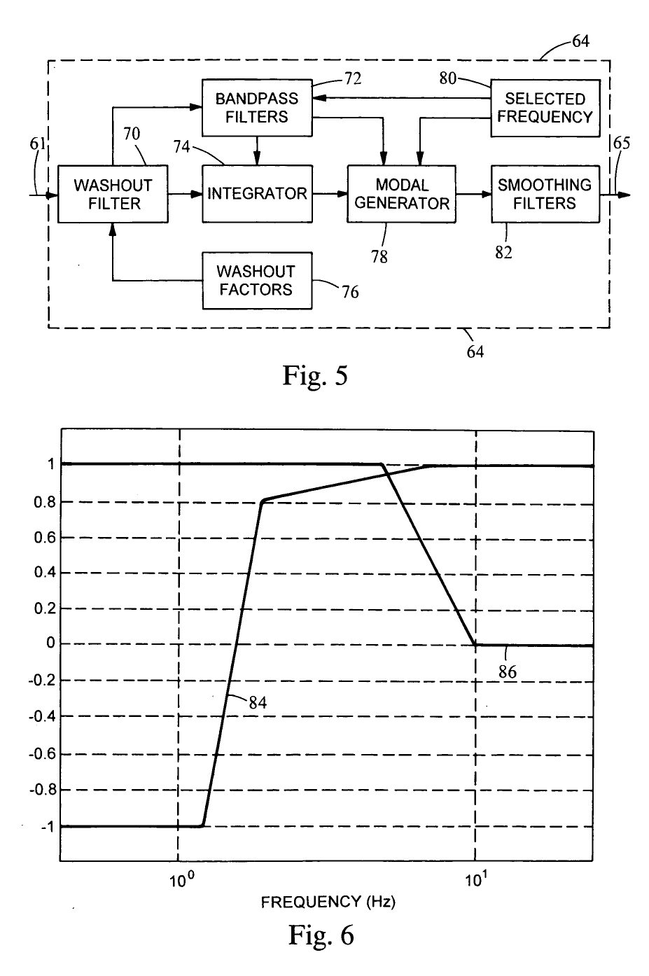

Now referring to FIG. 5, a description of the algorithm to extract the frequency amplitude at the selected frequency such as in blocks 64 and 66, is provided in reference to selection of the first frequency amplitude 65 (A₁). The high-pass filtered body relative velocity 61 is provided to a washout filter in block 70. The washout filter modifies the high-pass filtered body relative velocity 61 according to certain washout factors 76. The selected frequency 80 (ω₁), along with the result of the washout filter 70, is provided to a band-pass filter in block 72. The results from the band-pass filter 72 and the washout filter 70 are provided to an integrator 74. The result of the integrator 74 is provided, along with the result of the band-pass filter 72 and the selected frequency 80, to a modal generator in block 78. Utilizing the selected frequency information 80 the modal generator result is provided to a smoothing filter 82, which results in the frequency amplitude 65 (A₁).

Similarly, the above-described algorithm to extract the frequency amplitude at a selected frequency may be applied to the second frequency amplitude 67 (A₀) in the same manner.

Referring again to FIG. 4, the effective frequency ωᵢₑ₁ (i=h,p,r) is used for integrating different control strategies required for different frequency ranges. Similarly, the above procedure can be applied to the frequency range around the wheel-hop mode frequency ωᵢₑ₂ (i=h,p,r). For illustrative purposes the control algorithm for the low-band-width active suspension system is provided.

For the low bandwidth active suspension, a bandwidth of 5 to 7 Hz is targeted due to the limited capability of the DDPM with a limited power supply. Therefore, if the suspension dynamics dominate in the frequency range beyond the bandwidth, the control algorithm will set the DDPM to idle to save power and let the CFS work in a passive state. If the effective frequencies of the suspension dynamics are less than the bandwidth, the control algorithm can select different strategies to better isolate the vehicle body from the subjected vibrations. Those strategies can be stiff stiffness, soft stiffness, soft rebound damping, hard compression damping or variations thereon. In addition, a traditional passive shock absorber damping capability exists in the CFS, such as, hard damping for rebound and soft damping for compression.

Based on the effective frequencies ωie1 and ωᵢₑ₂ (i=h,p,r), strategy mappings can be determined for stiffness control and damping tuning with different effective frequencies as described in Tablel below. For example, if the heave body mode is 1.4 Hz, then the ωₕₑ₁-based strategy mapping can be −1 (representing stiff stiffness) for ωₕₑ₁ less than 0.9 Hz, 1 for ωₕₑ₁ near 1.4 Hz (and beyond), and a linearly interpolated value (or other curves) for ωₕₑ₁ between 0.9 and 1.4 Hz. The control signals may be reduced beyond the given bandwidth by: (1) Directly forcing the ωₕ₃₁-based strategy mapping to close to 0 if ωₕₑ₁ is close to 5 to 7 Hz and 0 beyond the bandwidth, (2) Using ωₕₑ₂ to identify the high frequencies so that the ωₕₑ₂-based strategy mapping is 1 below 5 to 7 Hz and becomes 0 beyond the bandwidth. The product of two strategy mappings, ωₕₑ₁ 84 and ωₕₑ₂ 86, for the stiffness control are shown in FIG. 6. Similarly the strategy mappings for heave damping can be properly derived from Table 1.

TABLE 1

| | Effective Freq | Adopted |
|---|---|---|
| | Range | Control Strategy |
| Ride Control | Low | Stiff Stiffness and |
| (i.e., Ride | | Hard Compression Damping |
| Comfort) | Body Mode | Small Stiffness |
| | <Bandwidth | Small Stiffness and Soft Damping |
| | >Bandwidth | Passive Suspension |
| | | (i.e., idle DDPM and no valve control) |

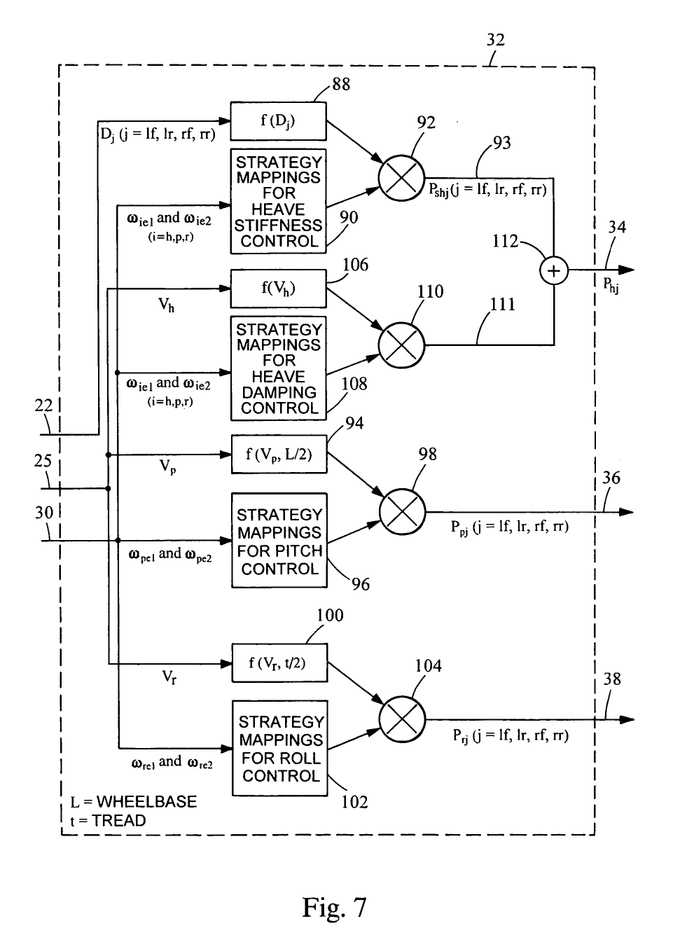

Now referring to FIG. 7, the desired strut pressure algorithm 32 is provided in more detail. The strut relative displacements 22 are provided to the transfer function f(Dᵢ) as provided in block 88. Further, f(Dᵢ) (i=lf, lr, rf and rr) is a function of the strut relative displacements, always no less than zero, and the outputs are desired pressures for each of the CFS. The strategy mapping is also used to decide whether a stiff or soft stiffness should be required for the feedback.

The effective frequency 30 (ωᵢₑ₁ and (ωᵢₑ₂) is provided to the strategy mapping for stiffness heave control as denoted by block 90. In block 92, the product of the transfer function from block 88 and the strategy mapping for stiffness heave control from block 90 is used to generate the desired strut stiffness heave pressure 93. The strut relative velocity 22 is provided to the transfer function f(Vₕ) as provided in block 106. Effective frequency 30 (ωᵢₑ₁ and ωᵢₑ₂) is provided to the strategy mapping for heave damping control as denoted by block 108. In block 110, the product of the transfer function from block 106 and the strategy mapping for heave damping control from block 108 is used to generate the desired strut heave damping pressure 111. The desired strut stiffness heave pressure 93 and the desired strut heave damping pressure 111 are combined in block 112 to generate the desired strut heave pressure 34.

For pitch control, the strut pitch relative velocity from the strut relative velocity 22 is provided to the transfer function f(Vₚ, L/2), where L is the wheelbase, as provided in block 94. The effective frequency 30 (ωₕₑ₁ and ωₕₑ₂) is provided to the strategy mapping for pitch control as denoted by block 96. In block 98, the product of the transfer function from block 94 and the strategy mapping for pitch control from block 96 is used to generate the desired strut pitch pressure 36.

Similarly, for roll control, the strut roll relative velocity from the strut relative velocity 22 is provided to the transfer function f(Vₚ, t/2), where t is the tread, as provided in block 100. The effective frequency 30 (ωₕₑ₁ and ωₕₑ₂) is provided to the strategy mapping for roll control as denoted by block 102. In block 104, the product of the transfer function from block 100 and the strategy mapping for roll control from block 102 is used to generate the desired strut roll pressure 38.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system for actively controlling the suspension of a vehicle comprising:
a plurality of adjustable struts;
an actuator coupled to the plurality of struts to effectuate adjustment thereof;
a plurality of displacement sensors, each displacement sensor configured to measure a displacement of one strut of the plurality of struts and generate strut relative displacement signals based on the displacement measured;
a controller in electrical communication with the plurality of sensors, wherein the controller is configured to determine a first frequency amplitude for heave, pitch, or roll of the vehicle based on the strut relative displacement signals and to actuate the actuator based thereon to control and adjust the suspension of the vehicle.

2. The system according to claim 1, wherein the controller includes a derivative filter to generate a strut relative velocity based on the strut relative displacement signals.

3. The system according to claim 2, wherein the controller is configured to generate body relative velocity based on the strut relative velocity.

4. The system according to claim 2, wherein the controller is configured to calculate a body relative heave velocity using the relationship Vₕ=(V_{lf}+Vₗᵣ+V_{rf}+Vᵣᵣ)/4, where i=lf, lr, rf and rr; and (V_{if},Vᵢᵣ,V_{rf},Vᵣᵣ) is the strut relative velocity.

5. The system according to claim 2, wherein the controller is configured to calculate the body relative pitch velocity using the relationship Vₚ=(V_{lf}−Vₗᵣ+V_{rf}−Vᵣᵣ)/(2*L), where i=lf, lr, rf and rr; L is the wheelbase; and (V_{lf},Vₗᵣ,V_{rf},Vᵣᵣ) is the strut relative velocity.

6. The system according to claim 2, wherein the controller is configured to calculate the body relative roll velocity using the relationship Vᵣ=(V_{lf}+Vₗᵣ−V_{rf}−Vᵣᵣ)/(2*t); where i=lf, lr, rf and rr; t is the tread; and (V_{lf},Vₗᵣ,V_{rf},Vᵣᵣ) is the strut relative velocity.

7. The system according to claim 1, wherein the controller is configured generate a body relative velocity based on the strut relative displacement signals.

8. The system according to claim 7, wherein the controller is configured to extract the first frequency amplitude based on the body relative velocity.

9. The system according to claim 8, wherein the controller is configured to apply a high pass filter to the body relative velocity before extracting the first frequency amplitude.

10. The system according to claim 7, wherein the controller is configured to extract a second frequency amplitude based on a body relative velocity.

11. The system according to claim 10, wherein the controller is configured to apply a low pass filter to the body relative velocity before extracting the second frequency amplitude.

12. The system according to claim 7, wherein the controller is configured to calculate an effective frequency based on the first and second frequency amplitudes.

13. The system according to claim 12, wherein the controller is configured to calculate an effective frequency based on the relationship A₁/A₀; where the first frequency amplitude is A₁ and the second frequency amplitude is A₀.

14. The system according to claim 12, wherein the controller is configured to calculate the desired heave strut pressure based on the strut relative displacement signals and the effective frequency.

15. The system according to claim 12, wherein the controller is configured to calculate the desired heave strut pressure based on strut relative velocity and the effective frequency.

16. The system according to claim 12, wherein the controller is configured to calculate the desired roll strut pressure based on strut relative velocity and the effective frequency.

17. The system according to claim 12, wherein the controller is configured to calculate the desired pitch strut pressure based on strut relative velocity and the effective frequency.

18. A method for actively controlling the suspension of a vehicle having adjustable struts and an actuator to adjust the struts, the method comprising:
sensing a relative strut displacement of the suspension;
calculating a strut relative velocity based on the strut relative displacement;
calculating a body relative velocity based on the strut relative velocity;
extracting a first frequency amplitude based on the body relative velocity; and
actuating the actuator based on the first frequency amplitude.

19. The method according to claim 18, further comprising extracting a second frequency amplitude based on the body relative velocity and actuating the actuator based on the second frequency amplitude.

20. The method according to claim 19, wherein the first frequency amplitude is calculated using a high-pass filter and the second frequency amplitude is calculated using a low-pass filter.

21. The method according to claim 19, further comprising calculating an effective frequency based on the relationship A₁/A₀; where the first frequency amplitude is A₁ and the second frequency amplitude is A₀.

22. The method according to claim 21, further comprising calculating a desired heave strut pressure based on the strut relative displacement signals and the effective frequency.

23. The method according to claim 21, further comprising calculating a desired heave strut pressure based on strut relative velocity and the effective frequency.

24. The method according to claim 21, further comprising calculating a desired roll strut pressure based on strut relative velocity and the effective frequency.

25. The method according to claim 21, further comprising calculating a desired pitch strut pressure based on the strut relative velocity and the effective frequency.

26. The method according to claim 18, wherein the strut relative velocity is calculated using a derivative filter.

27. The method according to claim 18, wherein the body relative velocity is calculated according to the relationship Vₕ=(V_{lf}+Vₗᵣ+V_{rf}+Vᵣᵣ)/44, Vₚ=(V_{lf}−Vₗᵣ+V_{rf}−Vᵣᵣ)/(2*L), Vᵣ=(V_{lf}+Vₗᵣ−Vᵣᵣ−Vᵣᵣ)/(2*t);
where Vₕ is the body relative heave velocity; Vₚ is the body relative pitch velocity; Vᵣ is the body relative roll velocity; i=lf, lr, rf and rr; (V_{lf},Vₗᵣ,V_{rf},Vᵣᵣ) is the strut relative velocity; L is the wheelbase; and t is the tread.
